(19) United States
(12) Patent Application Publication
(10) Pub. No.: US 2010/0322365 A1
(43) Pub. Date: Dec. 23, 2010

(54) SYSTEM AND METHOD FOR SYNCHRONIZING MULTI-CLOCK DOMAINS

(75) Inventors: Rostislav (Reuven) Dobkin, Hadera (IL); Ran Ginosar, Nofit (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: TECHNION RESEARCH AND DEVELOPMENT FOUNDATION LTD., Haifa, IL (US)

(21) Appl. No.: 12/486,906

(22) Filed: Jun. 18, 2009

(51) Int. Cl. H04L 7/00

(52) U.S. Cl. 375/354

(57) ABSTRACT

A universal synchronizer for preventing signals from first clock domain from causing metastability in sampling registers operating in a second clock domain. A first synchronization flip-flop receives a primary signal from the first clock domain and a second synchronization flip-flop generates a secondary signal synchronized with the second clock domain. Notably, logic is applied to intermediate signals passed between the first synchronization flip-flop and the second synchronization flip-flop.

### FIELD OF THE INVENTION

The present invention relates to systems and methods for data synchronization between different clock domains. More specifically, the invention relates to universal synchronizers having short latency, fast data transfer rates and which may support any clock relationship.

### BACKGROUND OF THE INVENTION

Systems on chip (SoC) often integrate multiple modules operating at different clock frequencies. Such systems are known as multiple clock domain (MCD) devices. Multiple clock domains need to be synchronized to prevent signals becoming metastable. Metastability may be the result of factors such the integration of domains having different external frequencies, the integration of modules designed to operate on different frequencies or such like. MCDs are needed to facilitate clock gating and partitioning of large and fast clock trees.

Clock pairs may be related in a number of ways depending upon the frequencies of the two domains and the phase differences between them. Clock pairs may be classified as:
Synchronous domains, which share the same frequency and have no phase difference;
Mesochronous domains, which share the same frequency but have a constant phase difference;
Multi-synchronous domains, in which the phase drifts slowly over time;
Plesiochronous domains, in which a very small frequency difference can be viewed as a phase drift;
Periodically varying domains, in which the a large frequency difference causes a predictable variation between the clocks, and
Asynchronous domains, in which the frequency and phase differences are unpredictable.

Synchronization may be optimized for some of the above scenarios by the use of specialist synchronizers which take advantage of the known the clock relationships. For example, mesochronous domains may use a simple FIFO (First In First Out) synchronizer. Multi-synchronous domains and plesiochronous domains may be synchronized using adaptive phase compensation. Periodically varying domains may be synchronized using a predictive synchronizer which foresees and prevents contentions. However, in the general asynchronous case in which the relationship between the clocks is not known, no specialist synchronizer may be used.

In the absence of specialist synchronizers, asynchronous domains are typically synchronized using universal synchronizers such as the family of two flip-flop (“two-flop”) synchronizers and two-clock FIFOs. Alternatively, more complex low-latency synchronizers may be employed, which use stoppable and locally-delayed clocks. However, low-latency synchronizers need to account for additional latency of clock tree delays and therefore require non-standard gates and incur timing assumptions. Consequently, low-latency synchronizers are generally restricted to a limited range of clock rates.

Two-flop synchronizers are often preferred over two-clock FIFOs, which have a relatively complex design that incurs higher data latency and does not support communications over long interconnects. Reference is now made to FIG. 1a showing a block diagram representing a simple four-phase two-flop synchronizer 10 of the PRIOR ART configured to synchronize separate clock domains of a transmitter 20 and a receiver 40.

FIG. 1b shows the finite state machine (FSM) for the transmitter 20 of FIG. 1a. The transmitter 20 is configured to wait for data until triggered by a valid indication signal V1. When the valid indication signal V1 is received, a request signal REQ is sent to the receiver 40. The transmitter 20 then waits for an acknowledgement signal ACK from the receiver 40. Once the acknowledgement signal ACK is received, a secondary acknowledgement signal A2 is generated, the REQ is reset to zero and the transmitter returns to waiting for data.

The request-sampling flip-flop 42 operates in the clock domain of the receiver 40 and is typically not therefore synchronized with the request signal REQ. Similarly, the acknowledgement-sampling flip-flop 22 operates in the clock domain of the transmitter 20 and is not synchronized with the acknowledgement signal ACK. The synchronizer 10 is provided to prevent metastability in the request-sampling flip-flop 42 and the acknowledgement-sampling flip-flop 22.

The synchronizer 10 includes a first pair of flip-flops 12A, 12B in the transmitter clock domain, and a second pair of flip-flops 14A, 14B in the receiver clock domain. The transmitter flip-flops 12 receive the acknowledgement signal ACK from the receiver 40 and generate a secondary request signal A2 which is synchronized with the transmitter clock domain. The receiver flip-flops 14 receive the request signal REQ from the transmitter 20 and generate a secondary request signal R2 which is synchronized with the receiver clock domain.

The internal signals S_{R}, S_{A} passing between each pair of synchronization flip-flops 12, 14 will occasionally become metastable. Therefore at least one clock cycle is preserved for metastability resolution before sampling the outgoing signals R2, A2. Another important requirement of the two-flop synchronizer 10 of the PRIOR ART is that no logic is applied to the potentially metastable internal signals S_{R}, S_{A}.

The actual length of the delay introduced by the transmitter flip-flops 12 and the receiver flip-flops 14 is determined by the Mean Time Between Failures requirements of the system. When the time required for metastability resolution is longer than a single clock cycle, additional flip-flops may be added to the transmitter flip-flops 12 and/or the receiver flip-flops 14. Alternatively, when the requirement is shorter than one half clock cycle, falling edge flip-flops may be alternatively employed.

Reference is now made to FIG. 1c, showing the overall State Transition Graph (STG) of the system, in which the symbol ‘+’ indicates a rising edge and the symbol ‘−’ denotes a falling edge. The cycle may be described as follows:
Provided that the synchronizer has finished its previous cycle (the secondary acknowledgement signal A2 is low) and an input valid indication signal V1 is received, the request signal REQ is sent from the transmitter at the next leading edge of the transmitter clock cycle;
The receiver flip flops 14 introduce a delay of at least one receiver clock cycle after which the secondary request signal R2 is generated at the next leading edge of the receiver clock cycle;
The acknowledgement signal ACK is sent from the receiver at the next leading edge of the receiver clock cycle;
The transmitter flip flops 12 introduce a delay of at least one transmitter clock cycle after which the secondary acknowledgement signal A2 is generated at the next leading edge of the transmitter clock cycle;
The request signal REQ is reset to zero at the first leading edge of the transmitter clock cycle following the generation of the secondary acknowledgement signal A2;
The secondary request signal R2 is reset to zero at the next leading edge of the receiver clock cycle following the receiver flip-flop delay;
The acknowledgement signal ACK is reset at the next leading edge of the transmitter clock cycle, and
The secondary acknowledgement signal A2 is reset at the next leading edge of the transmitter clock cycle following the transmitter flip-flop delay.

An output valid signal VO is pulsed for one receiver cycle after a new data word has been received and synchronized, and sent indication SNT is pulsed for one transmitter cycle after the secondary acknowledgement signal A2 is received.

The simple synchronizer enables reliable communication between two clock domains. Unfortunately, the two-flop synchronizer described above is limited to low data rates. In typical cases of mutually-asynchronous clocks, six transmitter cycles and six receiver cycles are required for a complete and acknowledged transfer of a single word.

FIG. 1d is a graphical illustration showing how the signals of the PRIOR ART system of FIG. 1a change over time for a case in which the transmitter and receiver clock domains are synchronized. Note that twelve clock cycles elapse between successive data packages being sent. Furthermore, the system of FIG. 1a has no READY signal, pausing the synchronizer when the receiver is not ready to receive (i.e., the acknowledgement signal ACK is not returned until READY becomes high). Where a READY signal is required the time elapse between data packages is increased still further.

It will be appreciated that fast data transfer rates are often necessary and that the latency associated with known synchronizers impedes the data transfer rate. There is therefore a need for a fast universal synchronizer and the present invention addresses this need.

### SUMMARY OF THE INVENTION

Embodiments of the current invention are directed towards presenting a universal synchronizer for preventing signals from first clock domain from causing metastability in sampling registers operating in a second clock domain. The synchronizer typically comprises: a first synchronization flip-flop for receiving a primary signal from the first clock domain and a second synchronization flip-flop for generating a secondary signal synchronized with the second clock domain. Notably, logic is applied to intermediate signals passed between the first synchronization flip-flop and the second synchronization flip-flop.

Optionally the synchronizer includes additional synchronization flip-flops between the first synchronization flip-flop and the second synchronization flip-flop, the additional synchronization flip-flops for providing additional clock cycle delays. Variously, the universal synchronizer includes at least one rising edge or at least one falling edge synchronization flip-flop.

Typically, the first clock domain is associated with a transmitter and the second clock domain is associated with a receiver. According to some embodiments, a first pair of synchronization flip-flops operates in the transmitter clock domain and a second pair of synchronization flip-flops operates in the receiver clock domain.

Usefully, a first primary signal comprises a request signal sent from the transmitter to the receiver, and a second primary signal comprises an acknowledgement signal sent from the receiver to the transmitter.

Optionally, a two-phase protocol may be used to validate data transfer. Alternatively, a four-phase protocol is used to validate data transfer.

Other embodiments of the invention are directed towards teaching a method for preventing signals from a first clock domain from causing metastability in sampling registers operating in a second clock domain. Typically, the method comprising the following steps:
providing a first synchronization flip-flop for receiving a primary signal from the first clock domain;
providing a second synchronization flip-flop for generating a secondary signal from the first clock domain, and
sampling an intermediate signal passed from the first synchronization flip-flop to the second synchronization flip-flop.

Optionally, the first clock domain is associated with a transmitter and the second clock domain is associated with a receiver. Typically, a two-phase or a four-phase protocol is used to validate data transfer.

Still further embodiments of the invention are directed towards universal synchronizer for preventing signals from first clock domain from causing metastability in sampling registers operating in a second clock domain wherein the synchronizer is physically distributed over a single chip.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1a is a block diagram representing a simple four-phase two-flop synchronizer of the PRIOR ART;

FIG. 1b is a finite state machine (FSM) for the transmitter side of the PRIOR ART system shown in FIG. 1a;

FIG. 1c is a State Transition Graph (STG) of the PRIOR ART system shown in FIG. 1a;

FIG. 1d is a graphical illustration showing how the signals of the PRIOR ART system shown in FIG. 1a change over time;

FIG. 2 is a block diagram representing a four-phase fast universal synchronizer according to a first embodiment of the present invention;

FIG. 3a is a finite state machine (FSM) for the transmitter side of the four-phase fast universal synchronizer;

FIG. 3b is a state transition graph (STG) of the four-phase fast universal synchronizer;

FIGS. 4a and 4b are graphical illustrations representing how the signals of the four-phase synchronizer change over time for the mesochronous case, in phase and in exact anti-phase respectively;

FIG. 5 is a block diagram representing a two-phase fast universal synchronizer according to a second embodiment of the present invention;

FIG. 6a is a finite state machine (FSM) for the transmitter side of the two-phase fast universal synchronizer;

FIG. 6b is a state transition graph (STG) of the two-phase fast universal synchronizer, and

FIGS. 7a, and 7b are graphical illustrations representing how the signals of the two-phase synchronizer change over time for the mesochronous case, in phase and out of phase respectively.

### DESCRIPTION OF THE PREFERRED EMBODIMENTS

Embodiments of the current invention aim to increase the data transfer rate of universal synchronizers by sampling and applying logic to the potentially metastable intermediate signals between the synchronization flip-flops.

Because the intermediate signals are potentially metastable, it is necessary to provide sufficient time for metastability resolution before sampling the intermediate signals. In various embodiments of the invention this is achieved by sampling the intermediate signals using registers having with two separate enable inputs. Alongside a first enablement input for receiving synchronized signals, a second enablement input if provided specifically for receiving potentially metastable intermediate signals.

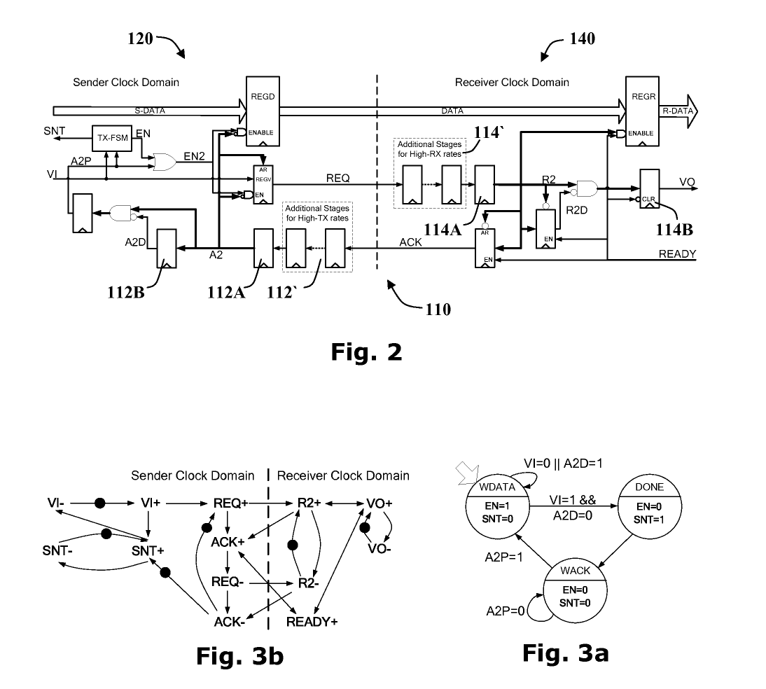

Reference is now made to FIG. 2 which shows a block diagram representing a four-phase universal synchronizer 110 according to a first embodiment of the present invention. The four-phase universal synchronizer 110 is configured to synchronize separate clock domains of a transmitter 120 and a receiver 140.

The four-phase synchronizer 110 includes a first pair of synchronization flip-flops 112A, 112B in the transmitter clock domain, and a second pair of synchronization flip-flops 114A, 114B in the receiver clock domain. The transmitter flip-flops 112A, 112B are configured to stabilize an acknowledgement signal ACK receiver 140 and the receiver flip-flops 114A, 114B are configured to stabilize a request signal REQ.

It will be appreciated that two-clock FIFO universal synchronizers of the prior art require many gates and memory to be added to the circuit and are therefore highly complex additions. Furthermore, FIFO arrangements are not distributable over the chip and are inappropriate for long range communication applications. The transmitter-receiver configuration of embodiments of the present invention, which enables distribution over the chip, may be used even such long range applications.

It is particularly noted that, in contradistinction to the prior art, logic is applied to the potentially metastable intermediate signals passed from the first transmitter synchronization flip-flop 112A and the second transmitter synchronization flip-flop 112B. In addition logic is also applied to the potentially metastable intermediate signals passed from the first receiver synchronization flip-flop 114A and the second receiver synchronization flip-flop 114B. The potentially metastable intermediate signals are indicated by the bold lines in FIG. 2.

While other logic may be synthesized normally, manipulation by the logic synthesizer and physical design software of the potentially metastable signals is avoided. Therefore, when optimizing the synchronizer using, for example, an EDA synthesis tool, optimization algorithms are generally constrained such that no modification of the potentially metastable connections is allowed.

In embodiments where either the transmitter 120 or in the receiver 140 have particularly fast clock-rates, additional flip-flops 112′, 114′ may be required to increase the number of clock-cycles in the time delay provided for metastability resolution. These additional flip-flops 112′, 114′ may be added before the first synchronization flip-flops 112A, 114A. Alternatively, where finer latency optimization is required, for example when only an additional half cycle is required, flip-flops triggered by the falling edge of the clock may be preferred. In embodiments in which at least one clock is slow, the metastability resolution time may be reduced by clocking the ACK and REQ sample registers with the falling edge.

The operation of the four-phase synchronizer 110 of the first embodiment may be described with reference to FIG. 3a showing the FSM of the transmitter 120 and FIG. 3b showing an STG of the overall synchronizer 110.
Initially, the transmitter is configured to wait for a data word to be registered by the transmitter's data register REGD, the arrival of a data word ready for sending is indicated by a rising valid indication signal VI;
when the valid indication signal VI is received, the transmitter's data register REGD and the transmission signal register REGV are both enabled;
on the next rising edge of the transmitter clock, the new data word DATA and request signal REQ are sent out;
at the receiver side, the data word DATA is registered by the receiver's data register REGR; and at the next rising edge of the receiver's clock cycle, the first receiver synchronization flip-flop 114A produces a secondary request signal R2;
if the ready signal READY is high, the receiver's data register REGR is enabled when the secondary request signal R2 rises;
at the next rising edge of the receiver's clock cycle, the data word R-DATA is sent out, an output validation signal VO is pulsed and the acknowledgement signal ACK is sent to the transmitter;
at the transmitter side, the first transmitter synchronization flip-flop 112A produces a secondary acknowledgement signal A2, thereby asynchronously resetting the request signal REQ and, at the next rising edge of the receiver's clock-cycle, the transmitter's data register REGD and the transmission signal register REGV are disabled (these remain disabled until the four-phase REQ/ACK handshake is over);
the resetting of the request signal REQ causes the secondary request signal R2 to fall to zero;
the falling edge of the secondary request signal R2 triggers an asynchronous de-assertion of the acknowledgement signal ACK, and
following the synchronized falling edge of the acknowledgement signal ACK the transmitter enables the next data cycle once a new data word is available.

Note that the sending of the data word R-DATA, the pulsing of the output valid signal VO, and the sending of the acknowledgement signal ACK all depend upon the secondary request signal R2. Because the secondary request signal R2 is potentially metastable, where required an extra clock cycle may be introduced to allow for metastability resolution. It is noted, however, that the secondary request signal R2 does not typically assume an illegal voltage level more than once every MTBF and in embodiments of the invention such metastability would only lead to non-determinism in timing.

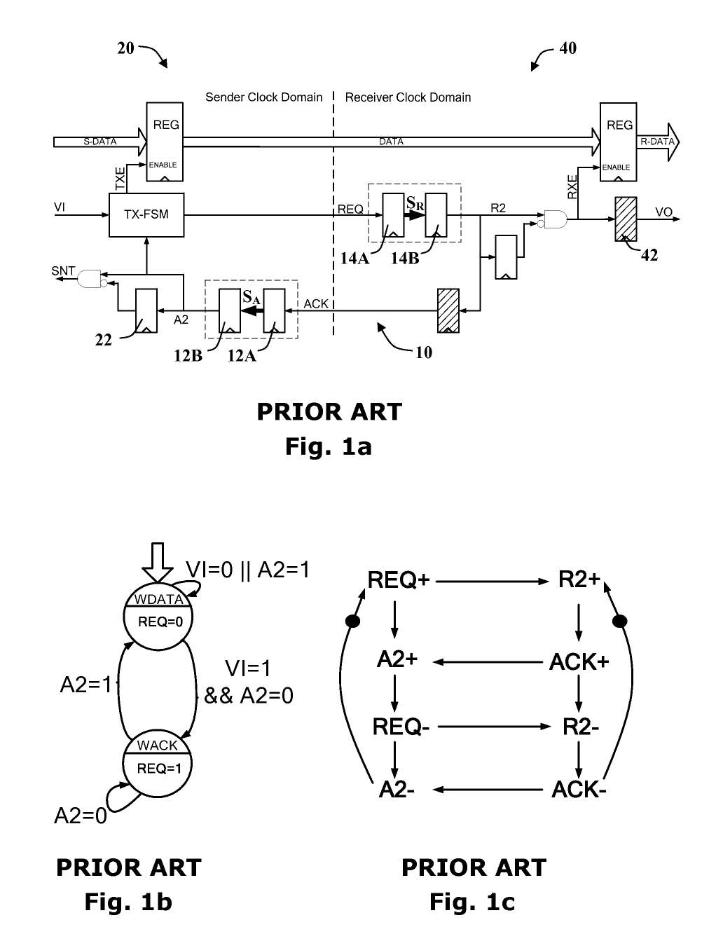

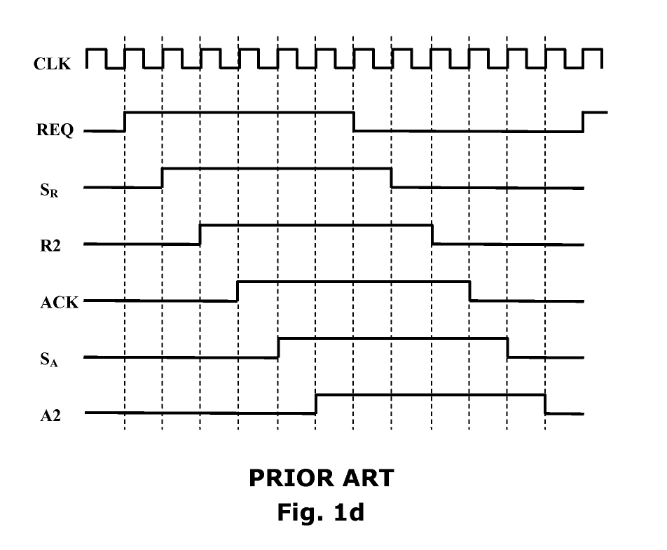

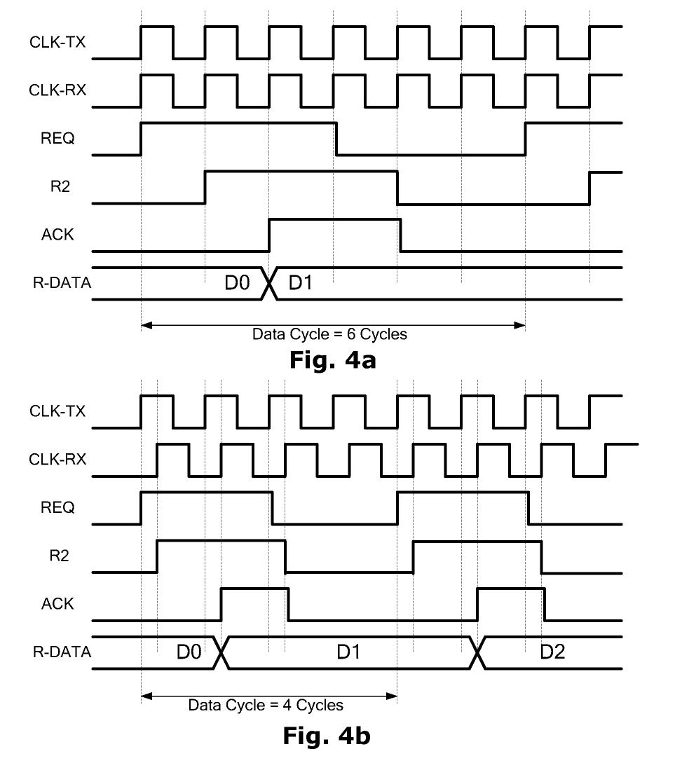

The increased data flow rate of the four-phase synchronizer may be highlighted with reference to FIGS. 4a and 4b showing graphical illustrations representing how the signals of the synchronizer 110 of the first embodiment change over time for the mesochronous case. With particular reference to FIG. 4a, showing the worst case scenario in which the transmitter clock rate CLK-TX and the receiver clock rate CLK-RX are in phase, it will be noted that the minimal data cycle time is six clock cycles. With reference to FIG. 4b, in which the clocks are out of phase, the minimal data cycle time is only four clock cycles when the two clocks are out of phase. It will be recalled that the minimal data cycle time for the PRIOR ART synchronizer, as highlighted in FIG. 1d, is at least twelve clock cycles.

Although only the mesochronous case is presented in FIGS. 4a and 4b, it will be appreciated that embodiments of the synchronizer 110 may synchronize transmitter and receiver clock domains with any class of relationship. Typically, when the clocks are mutually asynchronous, the data cycle depends largely on the slower clock. If the ratio between the clock rates is greater than two, then the data cycle is typically less than three clock-cycles of the slower clock.

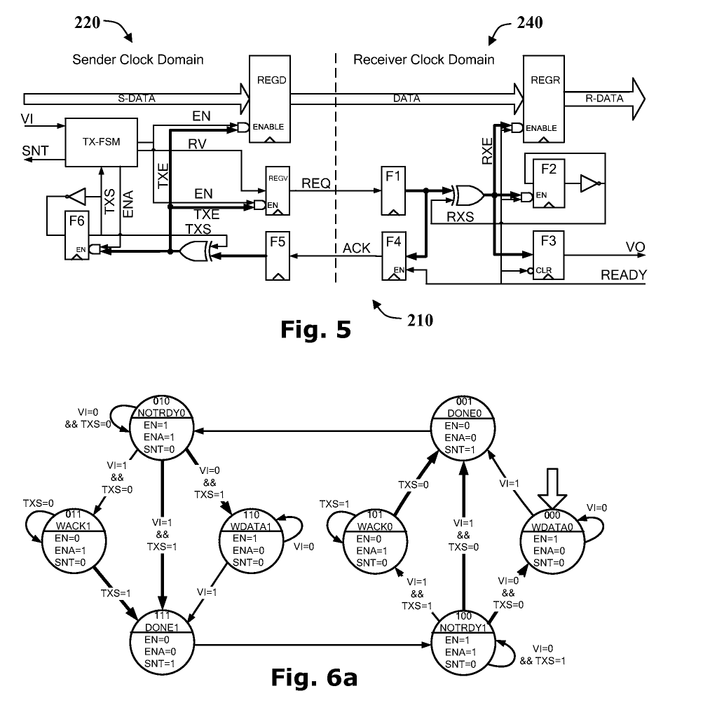

Reference is now made to FIG. 5 showing a block diagram representing a two-phase universal synchronizer 210 according to a second embodiment of the present invention. The two-phase universal synchronizer 210 is configured to synchronize a transmitter clock domain 220 and a receiver clock domain 240. The second embodiment of the synchronizer 210 uses a two-phase protocol to provide metastability resolution for the sampling flip-flops and further improves the data transfer rate significantly. It is noted that two-phase synchronizers may be of particular use for long range communication applications in which the wires themselves incur high latency.

As shown in FIG. 5, the two-phase synchronizer 210 of the second embodiment incorporates additional control logic. There is no asynchronous reset of the acknowledgement signal ACK, which is symmetric for the rising edge ACK+ and the falling edge ACK−. The time reserved for metastability resolution in the two-phase synchronizer 210 is shorter than in the four-phase synchronizer 110 of FIG. 2 due to the gate delay of an additional XOR gate 213.

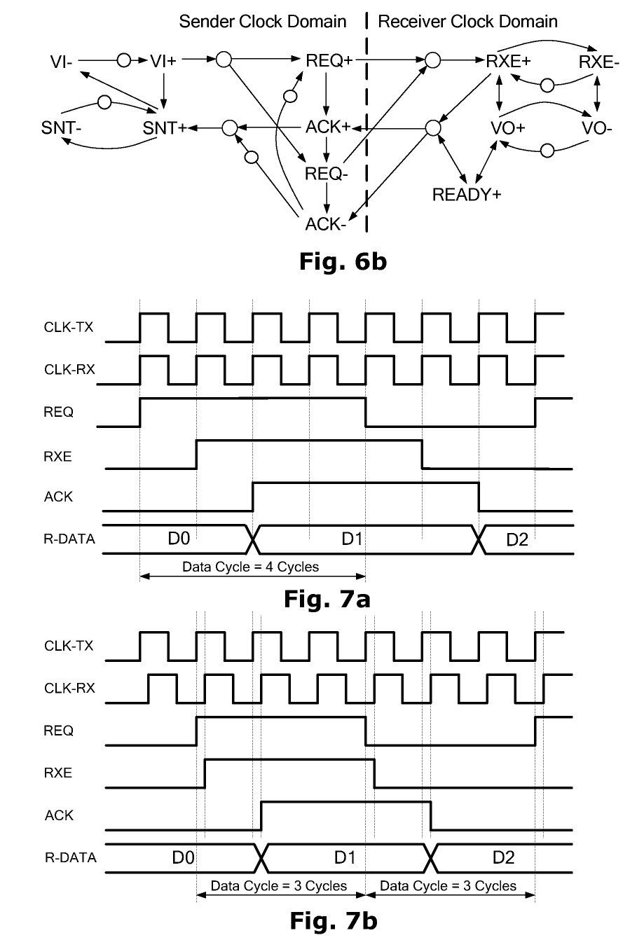

The synchronizer operation is explained with reference to FIG. 6a showing the FSM of the transmitter 220 and FIG. 6b showing the STG of the overall synchronizer 210. The transmitter state TXS is produced by the potentially metastable signals carried on the synchronization circuit (shown in bold). The toggle time therefore depends upon metastability resolution. With particular reference to FIG. 6a, the transmitter FSM accommodates this variability of toggling time. The output data register REGD and the output signal register REGV are controlled by the FSM and by the transmitter enablement signal TXE.

Reference is now made to FIG. 7a, and 7b, showing a graphical illustration representing how the signals of the synchronizer 210 of the second embodiment change over time for the mesochronous case. In the worst case, as shown in FIG. 7a, where the two clocks are in phase, the minimal data cycle time between consecutive rising edges of the request signal REQ+ is only four clock cycles. When the clocks are out of phase, as shown in FIG. 7b, the data cycle is only three clock cycles. It is noted that the value of the non-zero phase difference typically has no impact on the data cycle.

Note also that the two-phase synchronizer 210 of the second embodiment is a universal synchronizer capable of supporting any timing relationship between the transmitter 220 and receiver 240 clock domains. It will be appreciated that when the two clocks are asynchronous, the data cycle depends primarily upon the slower clock. In particular, in FIG. 7c, showing a graphical illustration representing how the signals of the synchronizer 210 of the second embodiment change over time when the frequency ratio is larger than two, only two clock cycles are required between consecutive rising edges of the request signal REQ+.

It can be demonstrated that the performance of the four-phase synchronizer 110 of the first embodiment and the two phase synchronizer of the second embodiment described hereinabove significantly improves the performance of typical two-flop synchronizers of the prior art.

The simple two-flop synchronizer 10 of the prior art requires twelve cycles for each data transfer and when one of the clocks is faster and the data cycle may be reduced to six cycles of the slower clock. In comparison, the two-phase synchronizer 210 of the second embodiment requires only four cycles which may be reduced to two clock cycles of the slower clock when the two clocks differ significantly in frequency.

Thus, although synchronizers need to be employed when transferring data across clock domain boundaries, prior art universal synchronizers incur a heavy performance penalty. Embodiments of the present invention, using two-phase of four-phase protocols, greatly improve the data transfer rate of universal synchronizers. The improved synchronizers can operate as fast as two clock cycles in certain cases. Moreover, this improvement is accentuated when the communicating clock domains are far away from each other, and the delays on the interconnecting lines need to be taken into account.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed:

1. A universal synchronizer for preventing signals from first clock domain from causing metastability in sampling registers operating in a second clock domain, said synchronizer comprising:
a first synchronization flip-flop for receiving a primary signal from said first clock domain, and
a second synchronization flip-flop for generating a secondary signal synchronized with said second clock domain;
wherein logic is applied to intermediate signals passed between said first synchronization flip-flop and said second synchronization flip-flop.

2. The universal synchronizer of claim 1, further comprising additional synchronization flip-flops between said first synchronization flip-flop and said second synchronization flip-flop, said additional synchronization flip-flops for providing additional clock cycle delays.

3. The universal synchronizer of claim 1, wherein at least one synchronization flip-flop comprises a rising edge flip-flop.

4. The universal synchronizer of claim 1, wherein at least one synchronization flip-flop comprises a falling edge flip-flop.

5. The universal synchronizer of claim 1, wherein said first clock domain is associated with a transmitter and said second clock domain is associated with a receiver.

6. The universal synchronizer of claim 5 comprising a first pair of synchronization flip-flops operating in the transmitter clock domain and a second pair of synchronization flip-flops operating in the receiver clock domain.

7. The universal synchronizer of claim 6, wherein a first primary signal comprises a request signal sent from said transmitter to said receiver.

8. The universal synchronizer of claim 6, wherein a second primary signal comprises an acknowledgement signal sent from said receiver to said transmitter.

9. The universal synchronizer of claim 5, wherein a two-phase protocol is used to validate data transfer.

10. The universal synchronizer of claim 5, wherein a four-phase protocol is used to validate data transfer.

11. A method for preventing signals from a first clock domain from causing metastability in sampling registers operating in a second clock domain, said method comprising the following steps:
(a) providing a first synchronization flip-flop for receiving a primary signal from said first clock domain;
(b) providing a second synchronization flip-flop for generating a secondary signal from said first clock domain, and
(c) sampling an intermediate signal passed from said first synchronization flip-flop to said second synchronization flip-flop.

12. The method of claim 11, wherein said first clock domain is associated with a transmitter and said second clock domain is associated with a receiver.

13. The method of claim 11, wherein a two-phase protocol is used to validate data transfer.

14. The method of claim 11, wherein a four-phase protocol is used to validate data transfer.

15. A universal synchronizer for preventing signals from first clock domain from causing metastability in sampling registers operating in a second clock domain wherein said synchronizer is physically distributed over a single chip.

16. The universal synchronizer of claim 15, said synchronizer comprising:
a first synchronization flip-flop for receiving a primary signal from said first clock domain, and
a second synchronization flip-flop for generating a secondary signal synchronized with said second clock domain;
wherein logic is applied to intermediate signals passed between said first synchronization flip-flop and said second synchronization flip-flop.

17. The universal synchronizer of claim 16, wherein said first clock domain is associated with a transmitter and said second clock domain is associated with a receiver.

18. The universal synchronizer of claim 17 comprising a first pair of synchronization flip-flops operating in the transmitter clock domain and a second pair of synchronization flip-flops operating in the receiver clock domain.

19. The universal synchronizer of claim 18, wherein a first primary signal comprises a request signal sent from said transmitter to said receiver.

20. The universal synchronizer of claim 18, wherein a second primary signal comprises an acknowledgement signal sent from said receiver to said transmitter.
